(19) United States
(12) Patent Application Publication
(10) Pub. No.: US 2026/0336771 A1
(43) Pub. Date: Oct. 29, 2026

(54) SYSTEM FOR ASSISTING IN TOWING OPERATIONS OF A FLOATING WIND TURBINE

(71) Applicant: KONGSBERG MARITIME AS, Kongsberg (NO)

(72) Inventor: Kristian Ivar OIEN, Kongsberg (NO)

(73) Assignee: KONGSBERG MARITIME AS, Kongsberg, NO (NO)

(21) Appl. No.: 19/487,284

(22) PCT Filed: Jun. 3, 2024
(86) PCT No.: PCT/NO2024/050129

§ 371 Date: Nov. 24, 2025

(30) Foreign Application Priority Data
Jun. 2, 2023 (NO) 20230636

(51) Int. Cl. B63B 77/10; B63B 21/16; B63B 21/56; B63B 35/44; B63B 79/10; B63B 79/40

(52) U.S. Cl. CPC B63B 77/10; B63B 21/16; B63B 21/56; B63B 35/44; B63B 79/10; B63B 79/40; B63B 2035/446

(57) ABSTRACT

It is disclosed a system and a method for assisting in towing operations of a floating wind turbine (FWT) An FWT is provided with a wireless communication system and at least one position sensor for measuring a position of the FWT in at least three degrees of freedom. A master tow vessel is connected to the floating wind turbine by a towline. The master tow vessel comprising a winch, a DP system, a two-way wireless communication system. A tow assist system/module/controller may be integrated with the DP system. An assisting tow vessel(s) is connected to the floating wind turbine by a towline. The assisting tow vessel(s) is provided with a two-way wireless communication system. The tow assist system/module/controller calculates set points (force and direction) for all the towing vessels based on input parameter(s) from the floating wind turbine, and input parameter(s) from each assisting towing vessel and input parameter(s) from the master tow vessel.

The present application is a national entry of PCT Application No. PCT/NO2024/050129, filed on Jun. 3, 2024, which claims priority to Norwegian Application NO 20230636, filed on Jun. 2, 2023. The entire contents of such prior applications are incorporated by reference herein.

### INTRODUCTION

The present invention concerns a tow assist system assisting in towing operations of a floating wind turbine (FWT).

### BACKGROUND

The traditional method for towing a floating wind turbine (FWT) from the yard to the field is to use a main towing vessel in addition to at least two support vessels that help stabilizing the sideways position of the floater. The operation is planned ahead based on a towing route. Line tensions and lengths are often precalculated for a fixed set of situations to control the towing line spread and depth. A person, “Towmaster”, on the main towing vessel monitors the overall situation and commands the support vessels during the tow-out, referring to the plan. This role requires a lot of experience.

When the floater arrives on location, all the vessels must be coordinated to keep the floater in position when mooring lines are connected. This often involves coordination with different installation vessels.

The floating wind turbine does not have any actuators or thrusters and is also a tall installation exposed to wind and waves that may increase the complexity of the towing and installation operation.

With the high volume that is planned for this market, there is a need for a system that assists the vessels in the towing and installation operation of the FWT with better efficiency and higher accuracy, without compromising on safety involved in these operations.

### SUMMARY OF THE INVENTION

The present invention provides a solution to at least some of the problems disclosed above. The invention is defined in the claims.

The invention provides in an aspect a system for assisting in towing operations of a floating wind turbine. The system comprising:
a floating wind turbine (FWT) comprising a wireless communication system and at least one position sensor for measuring a position of the floating wind turbine in at least three degrees of freedom;
a master tow vessel connectable to the floating wind turbine by a towline, the master tow vessel comprising a winch, a DP system, a two-way wireless communication system, and a tow assist system/controller wherein the tow assist system is integrated with the DP system;
at least one assisting tow vessel connectable to the floating wind turbine by a towline, the at least one assisting tow vessel comprising a two-way wireless communication system,
wherein the tow assist system is configured for calculating set points for the DP system of the master tow vessel based on at least one first input parameter from the floating wind turbine, and at least one second input parameter from the at least one assisting tow vessel and at least one third input parameter from the master tow vessel.

The tow assist system may further be configured for calculating set points for the winch control system for the master tow vessel. The set points for the winch control system may include at least one of towline tension and towline length. Calculating set points for the DP system may further comprise length of towline. The tow assist system may be configured for calculating set points for the at least one assisting tow vessel.

The at least one first input parameter from the floating wind turbine may comprise motions of the floating wind turbine including at least one of: surge, sway and yaw. The at least one first input parameter from the floating wind turbine may comprise motions of the floating wind turbine including at least one of heave, roll and pitch.

The at least one first input parameter from the floating wind turbine may comprise speed and acceleration in 6 degrees of freedom of the floating wind turbine.

The at least one second input parameter from the at least one assisting tow vessel may comprise thruster force of the at least one assisting tow vessel and a direction of the at least one assisting tow vessel. The at least one second input parameter from the at least one assisting tow vessel may comprise position of the at least one assisting tow vessel in at least three degrees of freedom.

The at least one second input parameter from the at least one assisting tow vessel comprising may comprise at least one of:
motions of the assisting tow vessel including at least one of heave, sway, surge, roll, pitch and yaw;
tension in the towline between the assisting tow vessel and the FWT;
length of the towline between the assisting tow vessel and the FWT.

The at least one third input parameter from the master tow vessel may comprise thruster force of the thrusters of the master tow vessel and a direction of the master tow vessel. The at least one third input parameter from the master tow vessel may comprise position of the master tow vessel in at least three degrees of freedom.

The at least one third input parameter from the master tow vessel may comprise at least one of:
motions of the master tow vessel including at least one of heave, sway, surge, roll, pitch and yaw;
tension in the towline between the master tow vessel and the FWT;
catenary of the towline between the master tow vessel and the FWT;
length of the towline between the master tow vessel and the FWT;
output from the winch control system of the master tow vessel.

The assisting tow vessel may further comprise a DP system. The assisting tow vessel may further comprise a winch with a winch control system. The FWT may further comprise at least one of a satellite navigation system or an inertial measurement unit or an inertial navigation system. The inertial measurement unit is at least one of a motion reference unit (MRU) and a motion gyro compass (MGC). The FWT comprising a differential GPS, a motion sensor and a gyro compass. INS provides increased control and high precision in weather conditions with wind, waves etc.

The invention provides in a further aspect a tow assist system for assisting in towing operations of a floating wind turbine. The tow assist system comprising:
an interface for integrating the tow assist system with a DP system enabling the tow assist system receiving at least one input parameter from the DP system and at least one input parameter from a winch control system;
an interface for receiving at least one first input parameter from the floating wind turbine;
wherein the tow assist system is adapted for calculating set points for a master tow vessel and at least one assisting tow vessel based on the at least one first input parameter from the floating wind turbine, and at least one second input parameter from a winch control system on at least one assisting tow vessel and at least one third input parameter from a DP system and a winch control system on the master tow vessel.

The tow assist system may further be adapted for calculating set points for the winch control system for the master tow vessel. The set points for the winch control system may comprise at least one of towline tension and towline length.

The set points for the master tow vessel may comprise thruster force for the at least one thruster of the master tow vessel and heading of the master tow vessel. The set points for the at least one assisting tow vessel may comprise thruster force for the at least one thruster of the at least one assisting tow vessel and a direction of the at least one assisting tow vessel.

The calculated set points for the DP system may further comprise length of towline.

The at least one first input parameter from the floating wind turbine may comprise a position of the floating wind turbine in at least three degrees of freedom. The at least one first input parameter from the floating wind turbine may comprise motions of the floating wind turbine including at least one of, sway, surge, and yaw. The at least one first input parameter from the floating wind turbine may comprise speed and acceleration in 6 degrees of freedom of the floating wind turbine. The at least one first input parameter from the floating wind turbine may comprise motions of the floating wind turbine including at least one of roll, pitch and heave.

The at least one second input parameter from the at least one assisting tow vessel may comprise thruster force of the at least one assisting tow vessel and a direction of the at least one assisting tow vessel. The at least one second input parameter from the assisting tow vessel may comprise a position of the assisting tow vessel in at least three degrees of freedom. The at least one second input parameter from the at least one assisting tow vessel may comprise motions of the assisting tow vessel including at least one of heave, sway, surge, roll, pitch and heave. The at least one second input parameter from the at least one assisting tow vessel may comprise at least one of:
tension in the towline between the assisting tow vessel and the FWT;
length of the towline between the assisting tow vessel and the FWT;

The at least one third input parameter from the master tow vessel may comprise thruster force of the thrusters of the master tow vessel and a direction of the master tow vessel. The at least one third input parameter from the master tow vessel may comprise position of the at least one assisting tow vessel in at least three degrees of freedom. The at least one third input parameter from the master tow vessel may comprise motions of the master tow vessel including at least one of sway, surge, and yaw.

The at least one third input parameter from the master tow vessel may comprise at least one of:
motions of the master tow vessel including at least one of heave, sway, surge, roll, pitch and yaw;
tension in the towline between the master tow vessel and the FWT;
catenary of the towline between the master tow vessel and the FWT;
length of the towline between the master tow vessel and the FWT;
output from the winch control system of the master tow vessel.

The invention provides in a further aspect a master tow vessel for assisting in a towing operation of a floating wind turbine. The master tow vessel connectable to the floating wind turbine by a towline, the master tow vessel comprising:
at least one thruster;
a winch and a DP system;
a two-way wireless communication system;
a tow assist system/controller wherein the tow assist system is integrated with the DP system; and
wherein the tow assist system is adapted for calculating set points for the master tow vessel and at least one assisting tow vessel based on at least one input parameter for assisting in towing operation of the floating wind turbine.

The tow assist system may further be adapted for calculating set points for a winch control system for the master tow vessel. Calculating set points for the DP system may further comprise length of towline.

The at least one input parameter may comprise at least one first input parameter from the floating wind turbine, and at least one second input parameter from the at least one assisting tow vessel and at least one third input parameter from the master tow vessel.

The at least one first input parameter from the floating wind turbine may comprise at least one of:
motions of the floating wind turbine including at least one of heave, sway, surge, roll, pitch and yaw;
speed and acceleration in 6 degrees of freedom of the floating wind turbine.

The tow assist system may be integrated with the DP system and the winch control system.

Calculating set points may further comprise calculating thruster force for the at least one thruster of the master tow vessel and calculating a direction of the master tow vessel.

The at least one first input parameter from the floating wind turbine may comprise at least one of:
position of the floating wind turbine in at least three degrees of freedom;
motions of the floating wind turbine including at least one of heave, sway, surge, roll, pitch and yaw;
speed and acceleration in 6 degrees of freedom of the floating wind turbine.

The at least one second input parameter from the at least one assisting vessel may comprise at least one of:
thruster force and heading of the at least one assisting vessel;
position of the at least one assisting vessel, preferably in at least three degrees of freedom;
motions of the at least one assisting vessel including at least one of heave, sway, surge, roll, pitch and yaw;
tension in towline between the assisting tow vessel and the FWT;
length of the towline between the assisting tow vessel and the FWT;
catenary of the towline between the assisting tow vessel and the FWT;
output from the DP system of the assisting vessel.

The at least one third input parameter from the master tow vessel may comprise thruster force of the thrusters of the master tow vessel and a direction/heading of the master tow vessel. The at least one third input parameter from the master tow vessel may comprise a position of the master tow vessel in at least three degrees of freedom.

The at least one third input parameter from the master tow vessel may comprise at least one of:
motions of the master tow vessel including at least one of heave, sway, surge, roll, pitch and yaw;
tension in the towline between the master tow vessel and the FWT;
catenary of the towline between the master tow vessel and the FWT;
length of the towline between the master tow vessel and the FWT;
output from the winch control system of the master tow vessel.

In a further aspect, the invention provides a method for assisting in a towing operation of a floating wind turbine. The method comprising:
towing the floating wind turbine by a master tow vessel and at least one assisting tow vessel where the master tow vessel and the at least one assisting tow vessel are connected to the floating wind turbine by towlines, wherein the master tow vessel is provided with a tow assist system;
receiving at least one first input parameter from at least one sensor on the floating wind turbine, wherein the at least one sensor including a position sensor for measuring a position of the floating wind turbine in at least three degrees of freedom;
wherein the tow assist system is adapted for calculating set points for the master tow vessel and the at least one assisting tow vessel based on the at least one first input parameter from the floating wind turbine, and at least one second input parameter from the at least one assisting tow vessel and at least one third input parameter from the master tow vessel.

The method may further comprise calculating set points for a winch control system for the master tow vessel, wherein the set points for the winch control system preferably comprising at least one of towline tension and towline length.

The method may further comprise calculating set points for a DP system of the master tow vessel, wherein the set points including a length of a towline between the master tow vessel and the floating wind turbine.

The set points for the DP system of the master vessel including thruster force of the thrusters of the master tow vessel and a heading of the master tow vessel.

The set points for the DP system of the at least one assisting tow vessel including thruster force of the thrusters of the at least one assisting tow vessel and a direction of the at least one assisting tow vessel.

The position of the floating wind turbine in at least three degrees of freedom may be a global position.

The set points are independent. The system may calculate set points for all the vessels involved in the towing operation. A DP system is not required to effectuate the operation. The vessels may be manually controlled to follow their set points. This enables use of different vessels and vessel types in the towing operation. Different vessel types may e.g. be tugboats, supply ships, anchor handling ships. If the vessels are provided with a DP system, it is possible to effectuate the operation in a fully automatic mode based on the set points provided by the tow assist system. A DP system is not required on the assisting vessels.

Motion parameters provides improved precision, control and security of the operation. The motion parameters may be provided by sensors on the FWT. Motion parameters may also be provided for each of the vessels involved in the towing operation.

Set points for the DP system of the master tow vessel may further include length of towline, providing more flexibility, control and security of the operation.

The parameters from the floating wind turbine may include motions of the floating wind turbine. The motions may include surge, sway and yaw.

The parameters from the floating wind turbine may further include motions of the floating wind turbine including at least heave, roll and pitch. By using measured data for surge, sway, yaw, heave, roll and pitch increased accuracy of the operation may be provided. Increased accuracy may be provided for the set points to the master tow vessel and the assisting tow vessels and the winch control systems.

Further, the parameters from the floating wind turbine may also include speed and acceleration in 6 degrees of freedom of the floating wind turbine. This will provide an even higher accuracy of the operation and an even higher accuracy of the setpoints provided to the master tow vessel and the assisting tow vessel and the winch control systems.

Surge, sway, yaw are the most important parameters from the FWT. Roll and pitch may provide further information to correct for e.g. the location of the antennae for the GPS. Heave is the least important parameter, as heave does not affect the position on the surface of the sea. Information about heave may provide extra information to the operator of the tow. Even further information increases the accuracy and safety of the towing operation of the FWT. The more parameters included in the calculation by the tow assist system, the more accurate would the positioning of the FWT be. The operator may e.g. be a human, a robot or humanoid or computer. The operation may be performed in autonomous, semi-autonomous or manual mode. Position on the surface of the sea is longitude and latitude.

Position from a GPS may also provide information about longitude, latitude and heading.

A dynamic positioning system may use the axis of the coordinate system for the vessel for both position and speed of the vessel.

The tow assist system may calculate the setpoints for all the towing vessels involved in the towing operation of the FWT. All the towing vessels actively affect the motions of the FWT. The towing operation may also function adequately even though the towing vessels follow the setpoints to a lower degree of accuracy, e.g. the towing vessels may be manually maneuvered or may take more time to follow the set points orders from the tow assist system, as long as there are measurements obtained of the parameters provided from the towing vessels which are transmitted to the tow assist system. In its simplest form it is possible to provide setpoints to one tow vessel towing the FWT. Setpoints to only one tow vessel may however result in less influence and precision than if there a tow vessels arranged in different directions in view of the FWT.

Surge, sway, yaw are the most important parameters as they provide the position on the surface of the sea. Roll and pitch contribute with corrections of the position. Heave may not be required.

Winch tension may be of particular importance as the tension of the towline influences the movement of the vessel. Towline length, towline catenary and towline output length are further information to the operator but may be far less important for the control of the towing operation.

The Tow Assist functionality ranges from improved situation awareness, advisory and control to a fully automated and integrated tow out and hook-up operation.

The intention of this functionality can be summarized with the following applications:
Reliable and efficient Towing Operations by improved awareness and better support for Towmasters. Improves the possibility to use vessel of opportunity around the world with less experience in similar operations.
Improved station keeping at site by receiving guidance on best positions and tension for tugs on a user-friendly interface.
Improve control during hook-up and tensioning by reducing peak/snap loads by having control of relative movements.

The Tow Assist may be divided in steps ranging from simply improved situation awareness to automation of processes.

### BRIEF DESCRIPTION OF DRAWINGS

Example embodiments are described with reference to the following drawings where:

FIG. 1 illustrates an exemplary embodiment of an overall concept with two different towing vessels attached with towlines to an FWT. A wireless communication between the two different vessels and a sensor kit on the FWT are shown as dotted lines;

FIG. 2 illustrates an exemplary schematic view of a tow assist situational awareness providing an overview of the towing situation onboard a master tow vessel for controlling the towing operation of the floating wind turbine, including historical positions to illustrate a dynamics of the towing situation;

FIG. 3 illustrates an exemplary schematic view of the tow assist towing wire catenary view of a tow assist system onboard the master vessel;

FIG. 4 illustrates an exemplary schematic view of setpoints for each towing vessel in a towing situation;

FIG. 5 is an exemplary view of a system topology for a tow assist system with four towing vessels.

### DETAILED DESCRIPTION

Example embodiments are described with reference to the drawings. The example embodiments are not limiting for the disclosure.

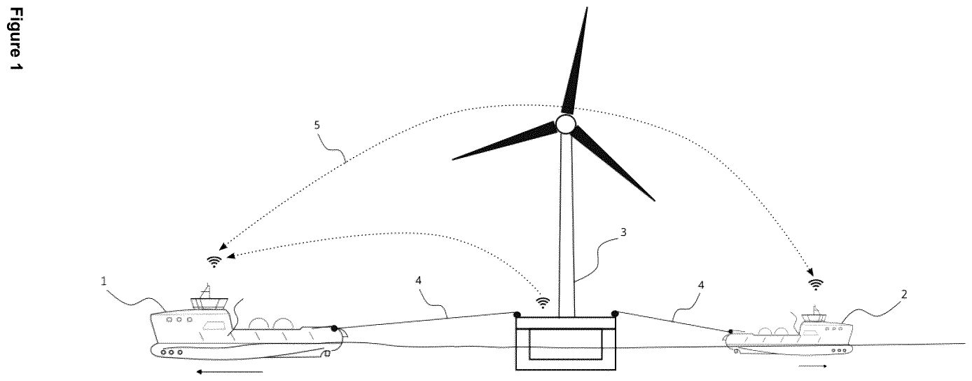

FIG. 1 illustrates a towing operation of a floating wind turbine (FWT). A master tow vessel 1 is connected to the floating wind turbine 3 with a towline 4. Another towing vessel 2 is also connected to the floating wind turbine with towline 4. The dotted lines 5 illustrate communication between different entities in a system; a tow assist system placed on the master tow vessel, a sensor kit placed on the FWT and the assisting tow vessel.

A satellite navigation system may be arranged on the FWT. The FWT may also be provided with an inertial measurement unit and/or an inertial navigation system. The inertial measurement unit may be a motion reference unit (MRU). The inertial measurement unit may be a motion gyro compass (MGC). The FWT may have both a MRU and MGC. A differential GPS, a motion sensor and a gyro compass may be arranged on the FWT.

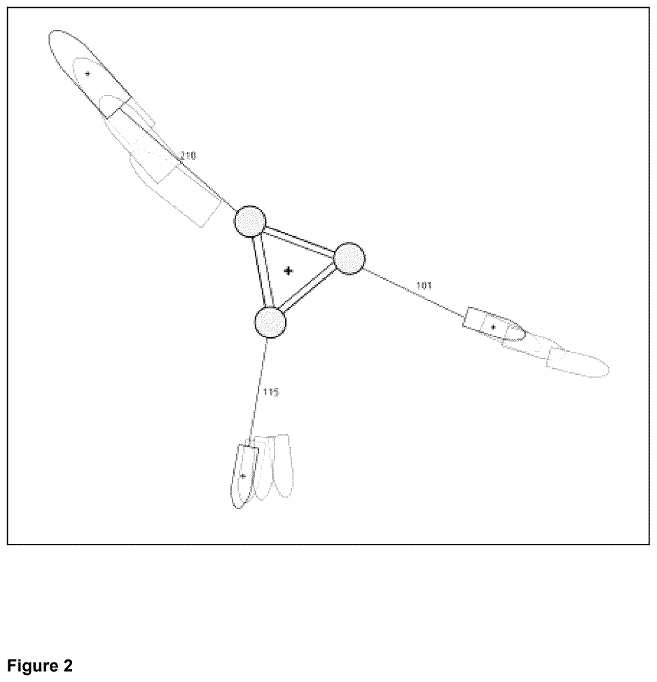

FIG. 2 illustrates an example of a main view of a tow assist situational awareness providing an overview of the towing situation onboard a master vessel for controlling the towing operation of the FWT. The floating wind turbine is illustrated with a triangular shape, but other shapes for the FWT may also be possible. The three tow vessels are connected to the floating wind turbine in different ones of the three corners of the triangle as illustrated in FIG. 1. The three tow vessels may then control the tow by pulling in each of the three corners in a coordinated manner. The three tow vessels are illustrated with the towline connected to the stern of the vessels. The towline may also be connected to the fore of the vessels. Each of the tow vessels are provided with a winch. The towline is connected to the winch. The winch is controlled by a winch control system.

### Vessel

The master tow vessel and the assisting tow vessels may be provided with a dynamic positioning (DP) system. Dynamic positioning (DP) involves automatic or semi-automatic control of a vessel's position and heading by using its own propellers and thrusters with respect to one or more position references. The dynamic positioning (DP) system may keep the position of a vessel fixed within given parameters or manoeuvre the vessel in a way that it could not do without the dynamic positioning system. A dynamic positioning (DP) system may manoeuvre a vessel based on a number of input parameters. These input parameters may e.g. come from:
sensors for location, heading, speed on the vessel;
sensors for external factors such as wind, waves, current; and
input from a user to execute a mission such as maintain position or move in a particular pattern.

The input from a user may e.g. be provided from an external control centre, from another vessel, from a captain onboard the vessel or via an interface from another system. The captain may input the mission data in a number of ways, including manually by use of mouse, on screen, voice etc.

Control algorithms of the dynamic positioning (DP) system takes in the sensor and user input parameters and executes manoeuvre of the vessel by controlling the on-board propellers and thrusters even with changes in external forces.

The DP system may be adapted for controlling the vessel based on at least one first input parameter which may comprise at least one of:
position of the floating wind turbine;
position of the vessel;
heading of the vessel;
thruster force of the vessel;
motions of the floating wind turbine including at least one of heave, sway, surge, roll, pitch and yaw;
motions of the vessel including at least one of heave, sway, surge, roll, pitch and yaw;
tension in the towline;
length of the towline;
catenary of the towline;
output from the winch control system of the vessel.

A winch control system may be adapted for controlling the winch 6 on the vessel based on at least one second input parameter, which may comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the towline; and
tension in the towline;
catenary of the towline;
output from the DP system of the vessel.

The master tow vessel and the assisting tow vessel(s) are connected to the floating wind turbine towlines. The towing vessels comprising onboard propeller and thrusters that may e.g. be manually controlled, semi-automatic controlled or controlled by a mission system or DP system. The towing vessels are provided with winches for reeling out and reeling in the towlines and controlling the towlines. The towing vessels are provided with a two-way wireless communication system.

The master tow vessel may include a DP system. The tow assist system/controller may be integrated with the DP system. As earlier explained, the tow assist system calculates set points for the master tow vessel and the at least one assisting tow vessel based on at least one input parameter for assisting in towing operation of the floating wind turbine. The tow assist system may calculate set points for a winch control system for the master tow vessel. Calculating set points for the DP system may include length of towline. The at least one input parameter may include parameter(s) from the floating wind turbine, parameter(s) from the at least one assisting tow vessel and parameter(s) from the master tow vessel.

Parameter(s) from the floating wind turbine may include a position of the floating wind turbine in at least three degrees of freedom. Parameter(s) from the floating wind turbine may include motions of the floating wind turbine as sway, surge, yaw, but also roll, pitch and heave. Motions may also include speed and acceleration in 6 degrees of freedom of the floating wind turbine.

The tow assist system may be integrated with the DP system and the winch control system. The DP system calculates set points for the master tow vessel including thruster force for the at least one thruster of the master tow vessel and a heading of the master tow vessel.

Parameter(s) from the assisting vessel(s) may include thruster force and heading of the at least one assisting vessel. Parameter(s) from the assisting vessel(s) may further include position of the at least one assisting vessel, preferably in at least three degrees of freedom.

Parameter(s) from the assisting vessel(s) may further include at least one of: motions of the at least one assisting vessel including at least one of heave, sway, surge, roll, pitch and yaw;
tension in towline between the assisting tow vessel and the FWT;
length of the towline between the assisting tow vessel and the FWT;
catenary of the towline between the assisting tow vessel and the FWT;
output from the DP system of the assisting vessel.

Parameter(s) from the master tow vessel include thruster force of the thrusters of the master tow vessel and a direction/heading of the master tow vessel.

Parameter(s) from the master tow vessel may also include position of the master tow vessel in at least three degrees of freedom.

Parameter(s) from the master tow vessel may include at least one of:
motions of the master tow vessel including at least one of heave, sway, surge, roll, pitch and yaw;
tension in the towline between the master tow vessel and the FWT;
catenary of the towline between the master tow vessel and the FWT;
length of the towline between the master tow vessel and the FWT;
output from the winch control system of the master tow vessel.

The tow assist system calculates set points for all the vessels involved in the towing operation. The set points from the tow assist system are independent. A DP system is not required to effectuate the operation. A DP system on the master tow vessel and the assisting tow vessel(s) may not be required. The vessels may be manually controlled to follow their set points calculated by the tow assist system. The master tow vessel may be provided with a DP system, but then the assisting vessel(s) may not require a DP system.

This enables use of different vessels and vessel types in the towing operation. Different vessel types may be e.g. tugboats, supply ships, anchor handling ships. If the master tow vessel and the assisting tow vessel(s) are provided with a DP system, it is possible to effectuate the operation in a fully automatic mode based on the set points provided by the tow assist system.

### Sensor Kit

A minimal standalone sensor kit can be placed on the floater and the support tugs to retrieve the required status data wirelessly as illustrated in FIG. 1.

Floater instrumentation kit is described in detail below. The instrumentation kit may also be arranged on the assisting towing vessels. The instrumentation kit may be provided in a compact unit placed on the floater. The instrumentation kit is removable from the floater. The instrumentation kit may include: a differential GPS for position measurements of the floater; a motion sensor and gyro compass for measuring roll, pitch, heave, heading, 6-DOF speed and acceleration; a Maritime Broadband radio for wireless transmission with the master tow vessel and possibly also the assisting tow vessel including two-way transmission; and battery or regular power supply providing power to the instrumentation kit components.

An example of an instrumentation kit installed on the floating wind turbine is explained below.

The floating wind turbine may be provided with an Inertial Navigation System (INS. The Inertial Navigation System may include at least one of a satellite navigation system (e.g. Global Navigation Satellite System (GNSS) or GPS) and an Inertial Measurement Unit (MRU or MGC) to measure position and movements of the floating wind turbine. The satellite navigation system may e.g. be GNSS, GPS, GLOANASS, BeiDou, Galileo, QZSS, IRNASS or NavIC. The Inertial Navigation System (INS) may be attached near the second sheave/guide where the towline exits the floating wind turbine. This enables monitoring of the floating wind turbine's movements; i.e. heave, sway, surge, roll, pitch and yaw. The floating wind turbine may further be provided with a communication system (transceiver) for communication of the signals from the floating instrumentation, e.g. signals from the Inertial Navigation System (INS), sensors and cameras, onboard the floating wind turbine to the installation vessel. The communication system may e.g. be a Marine Broadband Radio (MBR), but other wireless communication systems may also be used. The instrumentation on the floater may be pre-installed. The installation on the floater may be removable.

A first sensor for measuring the distance between the floating wind turbine and a tow vessel may be provided on the FWT and/or the vessel. The first sensor may typically be a distance sensor. The distance sensor may be an optical sensor. The optical sensor may be a laser or IR sensor. Other distance sensors like radar or ultrasound may also be used depending on the system and system requirements.

A relative movement between the master tow vessel and the floating wind turbine may alternatively be estimated indirectly by using data from at least two sensors, where at least one sensor is arranged on the master tow vessel and at least one sensor is arranged on the floating wind platform. The at least two sensors may be absolute position sensors.

The floating wind turbine (FWT) has a wireless communication system. The FWT is provided with at least one position sensor for measuring a position of the floating wind turbine in at least three degrees of freedom.

The system may be provided with at least one inertial navigation system (INS), which may be a satellite navigation system or an inertial measurement unit. The inertial measurement unit may be at least one of a motion reference unit (MRU) and a motion gyro compass (MGC).

### System Topology

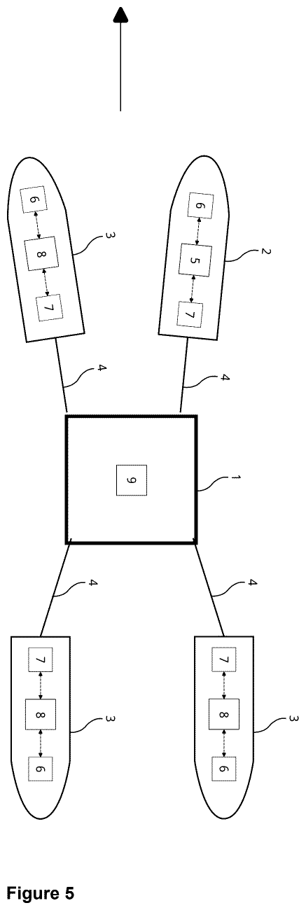

FIG. 5 illustrates an example of a towing setup with 4 towing vessels and the different systems involved. The FWT 1, in this case with a square shape, is fitted with a sensor kit 9. All towing vessels are connected to the FWT with individual tow lines 4.

The master tow vessel 2 may be provided with a dynamic positioning system (DP) 6 and a winch 7. The master tow vessel is also provided with a tow assist system (not shown). The winch is provided with a winch control system. The winch control system is arranged on the master tow vessel. The winch control system is connected to the DP control system for providing winch parameters to the DP control system and for control of the winch by the DP control system. The DP system may be integrated with the winch control system. The integration of the systems may provide an operator of the integrated DP and winch control system with improved operational overview.

The assisting towing vessels 3, may have the same onboard components as the master towing vessel. In the example embodiment in FIG. 5, the assisting towing vessels are provided with a tow assist sub system 8. The tow assist sub system is a sub system to the tow assist system. The tow assist sub system performs wireless communications with the tow assist system. The communication may be a two-way communication. The tow assist sub system may receive set points from the tow assist system on the master tow vessel. The tow assist sub system may also be integrated with the DP system onboard the assisting towing vessel. Tow assist sub system on the assisting vessel may in some embodiments also enable the assisting tow vessels to receive information from the FWT. The tow assist sub system may also not be integrated with the DP system. In case the tow assist sub system is not integrated with the DP system, set points from the assisting tow system may be displayed on a display onboard the assisting tow vessel. An operator of the assisting tow vessel may then use these set points for manual operation of the assisting tow vessel.

The dynamic positioning system (DP) on the master tow vessel 1 may also be provided with a special enhanced mission equipment functionality to control the master tow vessel during the tow operation also based on input from the sensor systems on the floating wind turbine 1. The dynamic positioning system on the master tow vessel may have a communication module to enable communication with the winch control system and for controlling the winch control system. As a security system in case of system failure, the DP system and the winch control system may be provided with manual controls for control by human personnel onboard the master tow vessel.

The floating wind turbine (FWT) instrumentation, the vessel winch (PIW) system and the dynamic positioning (DP) system of the master tow vessel, and possibly in some embodiments the assisting tow vessel(s) if provided with a DP system, work together to accomplish the mission of the tow operation procedure of the floating wind turbine. FIG. 5 illustrates this concept of integration between the instrumentation kit of the floating wind turbine, the winch and the dynamic positioning system. The floating wind turbine instrumentation 9 measure the floating wind turbine's position and movements (heave, sway, surge, roll, pitch, yaw). These position and movement parameters are transmitted to the master towing vessel. The dynamic positioning system controls the master towing vessel based on a number of parameters including the position of the master towing vessel and the position and movement parameters from the instrumentation on the floating wind turbine and compensates the relative movements between the floating wind turbine and the master tow vessel to enable a controlled towing operation.

The integration of the winch control system with the master tow vessel DP system, and possibly in some embodiments the assisting tow vessel(s) if provided with a DP system, enables to perform coordinated vessel positioning and winch pay-out/pay-in operation, and also to increase the overall safety in case of a vessel DP incident or winch failure.

A vessel processing unit on the master tow vessel may receive real time position from the floating wind turbine and calculate relative position, velocity and orientation and output these data to the DP and winch control system of the master tow vessel, and possibly also in some embodiments the assisting tow vessel(s) if provided with a DP system. A remote motion system is provided on the floating wind turbine. The remote motion system may include an inertial measurement unit, processing unit, battery. The remote motion system and the vessel processing unit may communicate through a Marine Broadband Radio (MBR) data link. Further details of these systems are explained later.

If the vessel (master tow vessel and possibly also in some embodiments the assisting tow vessel(s) if provided with a DP system) is provided with a dynamic positioning (DP) system, measuring movements in 2×6 degrees-of-freedom (DOF) and compensating movements in 2×6 degrees-of-freedom (DOF) is accomplished by synchronizing the DP control system and the winch control system. The DP control system and the winch control system are synchronized to maintain safety margins during an operation where the vessel ((master tow vessel and possibly also in some embodiments the assisting tow vessel(s) if provided with a DP system) and the floating wind turbine are connected together. Synchronization of the DP control system and the winch control system may involve at least one of position of floating wind turbine (e.g, measured with sensors on the floating wind turbine), position of vessel provided by the dynamic positioning system, position of the tow line provided by the winch/winch control system and operational status of the DP system and the winch/winch control system. The DP control system and the winch control system work together and know each other's operation based on the input parameters described and listed above. Each of the DP control system and the winch control system also knows the status of the other system. Status may be in the form of fault/error conditions or whether the systems operate as normal. This may be used to improve the security of the system if faults/errors happen. If one of the DP control system or winch control system fails during operation, i.e. if not able to keep precise position of vessel and towline, the remaining operational control system (DP or winch control system) will move the vessel to a position with increased safety margins. The towline may e.g. be brought into a safe position, the operation reversed or the operation aborted.

FIGS. 1, 2, 3, 5 illustrates exemplary system topologies for assisting in towing operations of a floating wind turbine. The floating wind turbine (FWT) has a wireless communication system and position sensor(s) for measuring a position of the floating wind turbine in at least three degrees of freedom. The master tow vessel has a winch and is connected to the FWT with a towline. The master tow vessel has a DP system. The master tow vessel is provided with a two-way wireless communication system for communication with the assisting tow vessel(s) and receiving information from the FWT. The master tow vessel may also receive set points from a tow assist system when the tow assist system is not arranged on the master tow vessel. The master vessel may also transmit information to the tow assist system. The tow assist system may be arranged on other vessels or remote locations e.g. onshore. The tow assist system/controller may be integrated with the DP system on the master tow vessel. The assisting tow vessel(s) are connected to the floating wind turbine by a towline. The assisting tow vessel(s) are also provided with a two-way wireless communication system for communicating with the master tow vessel and the other assisting tow vessel(s). The two-way wireless communication system may also communicate with the tow assist system. The assisting tow vessels may receive set points from a tow assist system via the wireless communication system. The assisting tow vessels may transmit information to the tow assist system via the wireless communication system. The tow assist system calculates set points for the DP system of the master tow vessel based on at least one first input parameter from the floating wind turbine, and at least one second input parameter from the at least one assisting tow vessel and at least one third input parameter from the master tow vessel.

The assisting tow vessel may also include a DP system. The assisting tow vessel is also provided with a winch and a winch control system.

Further details of the tow assist system will be explained below.

### Tow Assist System

The tow assist system may be a computer that is placed onboard the master towing vessel. To be able to control the position and speed of the unactuated floater the tow assist system uses a mathematical model that estimates the response of the floating structure when being actuated by the master tow vessel and the assisting vessels attached to the floating structure through the towing lines. The model estimates floater motions based on sensor measurements and feedback from the actuators onboard the master vessel and the assisting vessels. Actuators includes propellers and thrusters. In addition, the mathematical model considers the dynamics in the towing lines and the effect from the wind on the floating wind turbine.

Configuration of mathematical model:
Mass and drag properties of the floating wind turbine
Geometrical size of the floating wind turbine and connection points for the towing lines on the floating wind turbines for the towlines from the master vessel and the assisting vessels
Wind area in all directions of the floating wind turbine
Towing line characteristics (tension, length, catenary)

Inputs to the model is:
Desired position, heading and velocity of the tow
Measurements from the floater provided by the sensors in the instrumentation kit arranged on the floater
Wind measurement (received from DP system on the master tow vessel)
Feedback from actuators (received from the DP system on all vessels)

Output from the model is:
Desired force vector for all vessels involved in the towing operation including the master tow vessel and the assisting tow vessels.

### Secondary Tow Assist System

The secondary tow assist system is an interface unit placed on remote vessels with wireless link to the main tow assist system. Receives setpoints from the main tow assist system and sends feedback to the main tow assist system from sensors onboard the assisting tow vessels.

In an embodiment where the assisting vessels cannot be controlled automatically an extra screen may be provided onboard the assisting vessels. In this case the calculated setpoints from the main tow assist system may be presented to the operator of the assisting vessel that can control the assisting vessel manually in the tow operation.

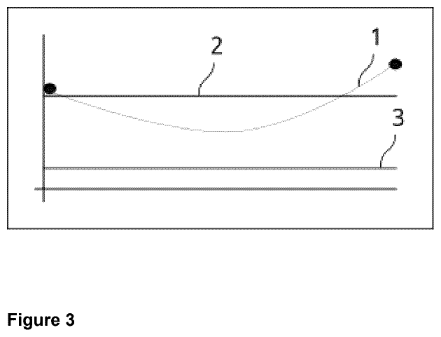

Catenary of the different towing lines may be visualized by utilizing data from the involved winches on the master tow vessel and the assisting vessel and the wire catenary models. This may be displayed on both the master tow vessel and the assisting tow vessel(s) as a x-y plot, see FIG. 3. The tow line 1 can be compared with the current water depth 3 and the water line 2.

The tow assist sub system explained above for the example in FIG. 5 may be a secondary tow assist system.

### Advisory and Control

The next step is extended functionality with model of the floater to calculate the forces needed to control it. The master towing vessel and support tugs (assisting tow vessels) are used as actuators on a passive floater, through the towing lines. From the desired floater position, an optimal setpoint, both for angle and total thruster force, for each of the tugs are calculated. Angle is a force angel. The set point for the angle is a vector with force and angel. With a continuous calculation of the setpoints and monitoring of the feedback the tow assist system can dynamically position the master tow vessel and possibly also the assisting tow vessel(s) along a desired path and control the towing speed.

In addition, the desired line tension, length and catenary can be monitored and adjusted in the total mathematical model, e.g. to handle narrow passages or shallow waters.

The final part is the way the setpoints are applied to all the connected vessels from the central tow assist system, typically placed on the main (master) towing vessel.

Based on the capability of the assisting vessels, the setpoints can either be presented to a local captain or directly integrated into control systems on the individual vessels. This is described in three different levels of integration below.

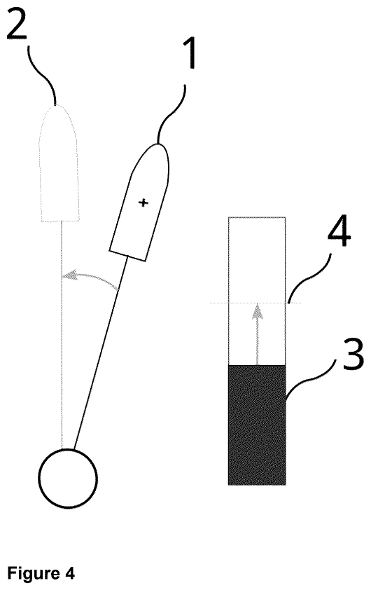

FIG. 4 illustrates an example of a setpoint view for the assisting vessels. The actual towing direction 1 is displayed together with the deviation from the desired towing direction 3 calculated by the tow assist system. The actual towing force 3 is displayed together with the deviation from the desired towing force 4 calculated by the tow assist system.

### Distributing the Setpoints from Tow Assist System to the Towing Vessels

The first level of integrated control displays the parameter(s) of interest to the Towmaster, such as optimal position, heading, thrust of the master tow vessel and the assisting tow vessels and/or the pay-out length of the towlines. The tow assist module/system calculates the parameters position, heading, thrust and/or the pay-out length for the towline for the support tugs and this is communicated manually via traditional channels. This means that there is no need for extra equipment on the tug, other than the sensor kit on the FWT which is used for situational awareness.

The second level moves the advisory to the support tugs. By adding an advisory kit with wireless communication to the tow assist system on the towing vessel, the tug operator sees the recommended position directly. This increases the tug response and improve the accuracy of the floater positioning. The advisory kit may include screen showing optimal vessel position, heading, thrust, winch pay-out. The data is received wirelessly, e.g. with an MBR, from the main towing vessel.

The tow assist sub system explained above for the example in FIG. 5 may in some embodiments be an advisory kit.

The third level includes a full integration between the tow assist system and the thrusters on the tug, which implies that the advised setpoints can be set directly without any human in the loop. At this level, a DP system or thruster control system with ability to receive and apply direct thruster setpoints is required on the tug.

This level of integration opens for an unmanned tug operation.

The tow assist system assist in towing operations of a floating wind turbine. The tow assist system has an interface for integrating the tow assist system with a DP system. The interface enabling the tow assist system receiving at least one input parameter from the DP system and at least one input parameter from a winch control system. An interface receives at least one first input parameter from the floating wind turbine. The tow assist system calculates set points for the towing vessels involved in the towing operation of the FWT. The towing vessels include a master tow vessel and at least one assisting tow vessel. The set points are calculated based parameter(s) from the floating wind turbine, input parameter(s) from winch control system(s) on the assisting tow vessel(s) and input parameter(s) from a DP system and a winch control system on the master tow vessel.

The tow assist system may calculate set points for the winch control system for the master tow vessel. The set points for the winch control system may include towline tension and/or towline length. Calculating set points for the DP system of the master tow vessel may include length of towline between the master tow vessel and the FWT. The tow assist system may also calculate set points for the assisting tow vessel(s).

The at least one first input parameter from the floating wind turbine may include position of the assisting tow vessel in at least three degrees of freedom. The input parameters may also include parameter(s) for the motions of the floating wind turbine. The motions may include surge, sway and yaw. Providing motion information from the FWT also including heave, roll and pitch may further increase the accuracy of the instructions (e.g. set points) provided by the tow assist module to the master tow vessel and the assisting vessel(s) taking part in the towing operation of the FWT. The parameters from the floating wind turbine may further include speed and acceleration in 6 degrees of freedom of the floating wind turbine. This will even further increase the accuracy of the operation and the calculated instructions by the tow assist system. Increase in accuracy increase the safety in the towing operation.

The at least one second input parameter from the at least one assisting tow vessel includes thruster force of the at least one assisting tow vessel and a direction of the at least one assisting tow vessel. Further, the parameter may include position of the at least one assisting tow vessel in at least three degrees of freedom. The at input parameter from the at least one assisting tow vessel may also include at least one of:
motions of the assisting tow vessel including at least one of heave, sway, surge, roll, pitch and yaw;
tension in the towline between the assisting tow vessel and the FWT;
length of the towline between the assisting tow vessel and the FWT.

Thruster force of the thrusters of the master tow vessel and a direction of the master tow vessel is provided to the tow assist system as the at least one third input parameter from the master tow vessel. A parameter related to the position of the master tow vessel may also be provided in at least three degrees of freedom. The at least one third input parameter from the master tow vessel may further include at least one of:
motions of the master tow vessel including at least one of heave, sway, surge, roll, pitch and yaw;
tension in the towline between the master tow vessel and the FWT;
catenary of the towline between the master tow vessel and the FWT;
length of the towline between the master tow vessel and the FWT;
output from the winch control system of the master tow vessel.

The floating wind turbine does not have any actuators or thrusters and is also a tall installation exposed to wind and waves that may increase the complexity of the towing and installation operation.

In an exemplary method the floating wind turbine is towed by a master tow vessel and at least one assisting tow vessel where the master tow vessel and the at least one assisting tow vessel are connected to the floating wind turbine by towlines. The master tow vessel is provided with the tow assist system. At least one first input parameter from at least one sensor on the floating wind turbine is received. The at least one sensor may include a position sensor for measuring a position of the floating wind turbine in at least three degrees of freedom. The tow assist system calculates set points for the master tow vessel and the at least one assisting tow vessel based on the at least one first input parameter from the floating wind turbine, at least one second input parameter from the at least one assisting tow vessel and at least one third input parameter from the master tow vessel.

The tow assist system may also calculate set points for a winch control system for the master tow vessel. The set points for the winch control system may be towline tension and/or towline length.

Calculation of set points for a DP system of the master tow vessel, may also include set points for the length of the towline between the master tow vessel and the floating wind turbine. Including length of towline increases the level of control of the towing situation and increased safety in the towing operation.

Further details of the method are also found in the explanation in the previous parts of this disclosure.

The invention includes any one or more of the following embodiment(s) in any combination(s) thereof, but each possible combination is not separately listed in the interests of brevity.
A system for assisting in towing operations of a floating wind turbine, the system comprising: a) a floating wind turbine (FWT) comprising a wireless communication system and at least one position sensor for measuring a position of the floating wind turbine in at least three degrees of freedom; b) a master tow vessel connectable to the floating wind turbine by a towline, the master tow vessel comprising a winch, a DP system, a two-way wireless communication system, and a tow assist system/controller wherein the tow assist system is integrated with the DP system; c) at least one assisting tow vessel connectable to the floating wind turbine by a towline, the at least one assisting tow vessel comprising a two-way wireless communication system; wherein the tow assist system is configured for calculating set points for the DP system of the master tow vessel based on at least one first input parameter from the floating wind turbine, and at least one second input parameter from the at least one assisting tow vessel and at least one third input parameter from the master tow vessel.
Any system herein described, wherein the tow assist system is further configured for calculating set points for the winch control system for the master tow vessel.
Any system herein described, wherein the set points for the winch control system comprising at least one of towline tension and towline length.
Any system herein described, where the calculating set points for the DP system further comprising length of towline.
Any system herein described, wherein the tow assist system is configured for calculating set points for the at least one assisting tow vessel.
Any system herein described, wherein the at least one first input parameter from the floating wind turbine comprises motions of the floating wind turbine including at least one of: surge, sway and yaw.
Any system herein described, wherein the at least one first input parameter from the floating wind turbine comprises motions of the floating wind turbine including at least one of heave, roll and pitch.
Any system herein described, wherein the at least one first input parameter from the floating wind turbine comprising speed and acceleration in 6 degrees of freedom of the floating wind turbine.
Any system herein described, wherein the at least one second input parameter from the at least one assisting tow vessel comprising thruster force of the at least one assisting tow vessel and a direction of the at least one assisting tow vessel.
Any system herein described, wherein the at least one second input parameter from the at least one assisting tow vessel comprising position of the at least one assisting tow vessel in at least three degrees of freedom.
Any system herein described, wherein the at least one second input parameter from the at least one assisting tow vessel comprising at least one of: i) motions of the assisting tow vessel including at least one of heave, sway, surge, roll, pitch and yaw; ii) tension in the towline between the assisting tow vessel and the FWT; iii) length of the towline between the assisting tow vessel and the FWT.
Any system herein described, wherein the at least one third input parameter from the master tow vessel comprising thruster force of the thrusters of the master tow vessel and a direction of the master tow vessel.
Any system herein described, wherein the at least one third input parameter from the master tow vessel comprising position of the master tow vessel in at least three degrees of freedom.
Any system herein described, wherein the at least one third input parameter from the master tow vessel comprising at least one of: i) motions of the master tow vessel including at least one of heave, sway, surge, roll, pitch and yaw; ii) tension in the towline between the master tow vessel and the FWT; iii) catenary of the towline between the master tow vessel and the FWT; iv) length of the towline between the master tow vessel and the FWT; v) output from the winch control system of the master tow vessel.
Any system herein described, wherein the assisting tow vessel further comprising a DP system.
Any system herein described, wherein the assisting tow vessel further comprising a winch with a winch control system.
Any system herein described, wherein the FWT further comprising at least one of a satellite navigation system or an inertial measurement unit or an inertial navigation system.
Any system herein described, wherein the inertial measurement unit is at least one of a motion reference unit (MRU) and a motion gyro compass (MGC).
Any system herein described, wherein the FWT comprising a differential GPS, a motion sensor and a gyro compass.
Tow assist system for assisting in towing operations of a floating wind turbine, the system comprising: a) an interface for integrating the tow assist system with a DP system enabling the tow assist system receiving at least one input parameter from the DP system and at least one input parameter from a winch control system; b) an interface for receiving at least one first input parameter from the floating wind turbine; wherein the tow assist system is adapted for calculating set points for a master tow vessel and at least one assisting tow vessel based on the at least one first input parameter from the floating wind turbine, and at least one second input parameter from a winch control system on at least one assisting tow vessel and at least one third input parameter from a DP system and a winch control system on the master tow vessel.
Any tow assist herein described, wherein the tow assist system is further adapted for calculating set points for the winch control system for the master tow vessel.
Any tow assist herein described, wherein the set points for the winch control system comprising at least one of towline tension and towline length.
Any tow assist herein described, wherein the set points for the master tow vessel comprising thruster force for the at least one thruster of the master tow vessel and heading of the master tow vessel.
Any tow assist herein described, wherein the set points for the at least one assisting tow vessel comprising thruster force for the at least one thruster of the at least one assisting tow vessel and a direction of the at least one assisting tow vessel.
Any tow assist herein described, where the calculated set points for the DP system further comprising length of towline.
A tow assist system, wherein the at least one first input parameter from the floating wind turbine comprising a position of the floating wind turbine in at least three degrees of freedom.
Any tow assist herein described, wherein the at least one first input parameter from the floating wind turbine comprises motions of the floating wind turbine including at least one of, sway, surge, and yaw.
Any tow assist herein described, wherein the at least one first input parameter from the floating wind turbine comprises speed and acceleration in 6 degrees of freedom of the floating wind turbine.
Any tow assist herein described, wherein the at least one first input parameter from the floating wind turbine comprises motions of the floating wind turbine including at least one of roll, pitch and heave.
Any tow assist herein described, wherein the at least one second input parameter from the at least one assisting tow vessel comprising thruster force of the at least one assisting tow vessel and a direction of the at least one assisting tow vessel.
Any tow assist herein described, wherein the at least one second input parameter from the assisting tow vessel comprising a position of the assisting tow vessel in at least three degrees of freedom.
Any tow assist herein described, wherein the at least one second input parameter from the at least one assisting tow vessel comprising motions of the assisting tow vessel including at least one of heave, sway, surge, roll, pitch and heave.
Any tow assist herein described, wherein the at least one second input parameter from the at least one assisting tow vessel comprising at least one of: tension in the towline between the assisting tow vessel and the FWT; or length of the towline between the assisting tow vessel and the FWT.
Any tow assist herein described, wherein the at least one third input parameter from the master tow vessel comprising thruster force of the thrusters of the master tow vessel and a direction of the master tow vessel.
Any tow assist herein described, wherein the at least one third input parameter from the master tow vessel comprising position of the at least one assisting tow vessel in at least three degrees of freedom.
Any tow assist herein described, wherein the at least one third input parameter from the master tow vessel comprising motions of the master tow vessel including at least one of sway, surge, and yaw.
Any tow assist herein described, wherein the at least one third input parameter from the master tow vessel comprising at least one of:
   motions of the master tow vessel including at least one of heave, sway, surge, roll, pitch and yaw;
   tension in the towline between the master tow vessel and the FWT;
   catenary of the towline between the master tow vessel and the FWT;
   length of the towline between the master tow vessel and the FWT;
   output from the winch control system of the master tow vessel.
A master tow vessel for assisting in a towing operation of a floating wind turbine, the master tow vessel connectable to the floating wind turbine by a towline, the master tow vessel comprising: at least one thruster; a winch and a DP system; a two-way wireless communication system; a tow assist system/controller wherein the tow assist system is integrated with the DP system; wherein the tow assist system is adapted for calculating set points for the master tow vessel and at least one assisting tow vessel based on at least one input parameter for assisting in towing operation of the floating wind turbine.
Any master tow vessel herein described, wherein the tow assist system is further adapted for calculating set points for a winch control system for the master tow vessel.
Any master tow vessel herein described, wherein calculating set points for the DP system further comprising length of towline.
Any master tow vessel herein described, the at least one input parameter comprising at least one first input parameter from the floating wind turbine, and at least one second input parameter from the at least one assisting tow vessel and at least one third input parameter from the master tow vessel.
Any master tow vessel herein described, wherein the at least one first input parameter from the floating wind turbine comprising at least one of: motions of the floating wind turbine including at least one of heave, sway, surge, roll, pitch and yaw; or speed and acceleration in 6 degrees of freedom of the floating wind turbine.
Any master tow vessel herein described, wherein the tow assist system is integrated with the DP system and the winch control system.
Any master tow vessel herein described, wherein calculating set points further comprising calculating thruster force for the at least one thruster of the master tow vessel and calculating a direction of the master tow vessel.
Any master tow vessel herein described, wherein the at least one first input parameter from the floating wind turbine comprises at least one of: position of the floating wind turbine in at least three degrees of freedom; motions of the floating wind turbine including at least one of heave, sway, surge, roll, pitch and yaw; speed and acceleration in 6 degrees of freedom of the floating wind turbine.
Any master tow vessel herein described, wherein the at least one second input parameter from the at least one assisting vessel further comprises at least one of: thruster force and heading of the at least one assisting vessel; position of the at least one assisting vessel, preferably in at least three degrees of freedom; motions of the at least one assisting vessel including at least one of heave, sway, surge, roll, pitch and yaw; tension in towline between the assisting tow vessel and the FWT; length of the towline between the assisting tow vessel and the FWT; catenary of the towline between the assisting tow vessel and the FWT; output from the DP system of the assisting vessel.
Any master tow vessel herein described, wherein the at least one third input parameter from the master tow vessel comprising thruster force of the thrusters of the master tow vessel and a direction/heading of the master tow vessel.
Any master tow vessel herein described, wherein the at least one third input parameter from the master tow vessel comprising a position of the master tow vessel in at least three degrees of freedom.
Any master tow vessel herein described, wherein the at least one third input parameter from the master tow vessel comprising at least one of: motions of the master tow vessel including at least one of heave, sway, surge, roll, pitch and yaw; tension in the towline between the master tow vessel and the FWT; catenary of the towline between the master tow vessel and the FWT; length of the towline between the master tow vessel and the FWT; output from the winch control system of the master tow vessel.
A method for assisting in a towing operation of a floating wind turbine, the method comprising: a)towing the floating wind turbine by a master tow vessel and at least one assisting tow vessel where the master tow vessel and the at least one assisting tow vessel are connected to the floating wind turbine by towlines, wherein the master tow vessel is provided with a tow assist system; receiving at least one first input parameter from at least one sensor on the floating wind turbine, wherein the at least one sensor including a position sensor for measuring a position of the floating wind turbine in at least three degrees of freedom; wherein the tow assist system is adapted for calculating set points for the master tow vessel and the at least one assisting tow vessel based on the at least one first input parameter from the floating wind turbine, and at least one second input parameter from the at least one assisting tow vessel and at least one third input parameter from the master tow vessel.
Any method for assisting in a towing operation herein described, further comprising calculating set points for a winch control system for the master tow vessel, wherein the set points for the winch control system preferably comprising at least one of towline tension and towline length.
Any method for assisting in a towing operation herein described, further comprising calculating set points for a DP system of the master tow vessel, wherein the set points including a length of a towline between the master tow vessel and the floating wind turbine.

Having described example embodiments of the invention it will be apparent to those skilled in the art that other embodiments incorporating the concepts may be used. These and other examples illustrated above are intended by way of example only and the actual scope of the invention is to be determined from the following claims.

1. A system for assisting in towing operations of a floating wind turbine, the system comprising:
a floating wind turbine (FWT) comprising a wireless communication system and at least one position sensor for measuring a position of the floating wind turbine in at least three degrees of freedom;
a master tow vessel connectable to the floating wind turbine by a towline, the master tow vessel comprising a winch, a dynamic positioning (DP) system, a two-way wireless communication system, and a tow assist system/controller wherein the tow assist system is integrated with the DP system;
at least one assisting tow vessel connectable to the floating wind turbine by a towline, the at least one assisting tow vessel comprising a two-way wireless communication system,
wherein the tow assist system is configured for calculating set points for the DP system of the master tow vessel based on at least one first input parameter from the floating wind turbine, and at least one second input parameter from the at least one assisting tow vessel and at least one third input parameter from the master tow vessel.

2. The system according to claim 1, wherein the tow assist system is further configured for calculating set points for the winch control system for the master tow vessel.

3. The system according to claim 2, wherein the set points for the winch control system comprising at least one of a towline tension and a towline length.

4. The system according to claim 1, where the calculating set points for the DP system further comprises a length of towline.

5. The system according to claim 1, wherein the tow assist system is configured for calculating set points for the at least one assisting tow vessel.

6. The system according to claim 1, wherein the at least one first input parameter from the floating wind turbine comprises motions of the floating wind turbine including at least one of: surge, sway, and yaw.

7. The system according to claim 1, wherein the at least one first input parameter from the floating wind turbine comprises motions of the floating wind turbine including at least one of heave, roll, and pitch.

8. The system according to claim 1, wherein the at least one first input parameter from the floating wind turbine comprises speed and acceleration in 6 degrees of freedom of the floating wind turbine.

9. The system according to claim 1, wherein the at least one second input parameter from the at least one assisting tow vessel comprises a thruster force of the at least one assisting tow vessel and a direction of the at least one assisting tow vessel.

10. The system according to claim 1, wherein the at least one second input parameter from the at least one assisting tow vessel comprises a position of the at least one assisting tow vessel in at least three degrees of freedom.

11. The system according to claim 1, wherein the at least one second input parameter from the at least one assisting tow vessel comprises at least one of:
motions of the assisting tow vessel including at least one of heave, sway, surge, roll, pitch, and yaw;
tension in the towline between the assisting tow vessel and the FWT;
length of the towline between the assisting tow vessel and the FWT.

12. The system according to claim 1, wherein the at least one third input parameter from the master tow vessel comprises a thruster force of the thrusters of the master tow vessel and a direction of the master tow vessel.

13. The system according to claim 1, wherein the at least one third input parameter from the master tow vessel comprises a position of the master tow vessel in at least three degrees of freedom.

14. The system according to claim 1, wherein the at least one third input parameter from the master tow vessel comprises at least one of:
motions of the master tow vessel including at least one of heave, sway, surge, roll, pitch, and yaw;
tension in the towline between the master tow vessel and the FWT;
catenary of the towline between the master tow vessel and the FWT;
length of the towline between the master tow vessel and the FWT;
output from the winch control system of the master tow vessel.

15. The system according to claim 1, wherein the assisting tow vessel further comprises a DP system.

16. The system according to claim 1, wherein the assisting tow vessel further comprises a winch with a winch control system.

17. The system according to claim 1, wherein the FWT further comprises at least one of a satellite navigation system or an inertial measurement unit or an inertial navigation system.

18. The system according to claim 17, wherein the inertial measurement unit is at least one of a motion reference unit (MRU) and a motion gyro compass (MGC).

19. The system according to claim 1, wherein the FWT comprises a differential GPS, a motion sensor, and a gyro compass.

20-50. (canceled)

51. A method for assisting a towing operation of a floating wind turbine, the method comprising:
towing the floating wind turbine by a master tow vessel and at least one assisting tow vessel where the master tow vessel and the at least one assisting tow vessel are connected to the floating wind turbine by towlines, wherein the master tow vessel is provided with a tow assist system;
receiving at least one first input parameter from at least one sensor on the floating wind turbine, wherein the at least one sensor includes a position sensor for measuring a position of the floating wind turbine in at least three degrees of freedom;
wherein the tow assist system is adapted for calculating set points for the master tow vessel and the at least one assisting tow vessel based on the at least one first input parameter from the floating wind turbine, and at least one second input parameter from the at least one assisting tow vessel and at least one third input parameter from the master tow vessel.

52. The method according to claim 51, further comprising calculating set points for a winch control system for the master tow vessel, wherein the set points for the winch control system preferably comprises at least one of towline tension and towline length.

53. The method according to claim 51, further comprising set points for a DP system of the master tow vessel, wherein the set points include a length of a towline between the master tow vessel and the floating wind turbine.
